(19) United States
(12) Patent Application Publication
(10) Pub. No.: US 2013/0148178 A1
(43) Pub. Date: Jun. 13, 2013

(54) DIFFRACTIVE MOTION OSM AUTHENTICATOR

(71) Applicants: Frantz Mercier, Hollister, CA (US); Robert Lawrence Hazel, Foster City, CA (US)

(72) Inventors: Frantz Mercier, Hollister, CA (US); Robert Lawrence Hazel, Foster City, CA (US)

(73) Assignee: LASERCARD CORPORATION, Mountain View, CA (US)

(21) Appl. No.: 13/324,752

(22) Filed: Dec. 13, 2011

(51) Int. Cl. G03H 1/00

(52) U.S. Cl. 359/2

(57) ABSTRACT

An identification document authenticator and method of operating the same is disclosed. Specifically, the authenticator is equipped with a light source that illuminates an identification document. Authentic identification documents may comprise one or more diffractive elements that, when illuminated, generate a unique image. The image is then viewable via a viewer provided on the authenticator.

### FIELD OF THE DISCLOSURE

The present disclosure is generally directed toward document authentication and specifically directed toward optical-based authentication mechanisms.

### BACKGROUND

The use of identification documents and other credentials is pervasive. Credentials are used on a daily basis for a number of different purposes. Credentials are most commonly used to prove identity, to verify age, to access an asset (e.g., secure area, financial account, computing resource, etc.), to evidence driving privileges, to cash a check, and so on. Airplane passengers are required to show a credential during check in, and sometimes at security screening and prior to boarding their flight. We also live in an ever-evolving cashless society where credentials are used to make payments, access an automated teller machine (ATM), debit an account, or make a payment, etc. Many industries require that their employees carry photo identification credentials on the job and to access various locations on a job site.

While many different types of security features have been developed to enhance the security associated with credentials, few have been as useful and difficult to copy as holographic features. Most credential holographic security features are attached to the credential base during the manufacturing process. If the credential is in part an optical recording medium, then it is possible to record the hologram directly into the medium. A practical implementation of this concept presents a large number of technical and price hurdles especially if the medium is not tailored for holographic recording. A complex optical system is required to record a quality hologram. The plastics industry is working with companies specializing in holography to develop an optical medium suitable for both holographic data storage and personalized holograms visible in natural light.

For security holograms, the optical recording requirement can be eliminated by creating a computer generated hologram on the master of formatted medium information (the photo mask). This becomes practical if the lithographic process has sub-micron resolution and the formatted medium has good diffraction characteristics (a contoured surface). The resulting security hologram is more secure than the attached holograms currently employed on bank cards. In the latter case, a counterfeited label can be attached to a bank card. To counterfeit a hologram which is a part of the credential optical medium format, on the other hand, the whole medium must be counterfeited.

### SUMMARY

It is, therefore, one aspect of the present disclosure to provide a credential with one or more security features, such as diffractive security holograms. It is also an aspect of the present disclosure to provide an authenticator that enables easy and convenient authentication of such credentials.

In some embodiments, an authentic credential is provided with one or more diffractive security features. One example of a diffractive security feature is a feature that is a formatted digitally-mastered hologram created by a software program. The diffractive security feature can be located at one or more positions on a credential. The diffractive security feature may comprise a plurality of diffractive elements (e.g., independent images). In some embodiments, the diffractive element may have a maximum vertical and/or horizontal dimension of about 3 mm. The shape of the diffractive element, however, has no impact on the holographic produced provided that the light source used to recreate the image is largely confined to the area within the boundary.

In some embodiments, a diffractive element provided on an authentic credential generates an image when it is illuminated with a light source, such as a collimated laser beam. The diffractive element, when illuminated, generates a unique image that is easily identified visually. The diffracted light behaves as if it is emanating from the pinhole of a pinhole camera. This means that the image can be generated by placing a flat screen in the path of the reflected light. There is no focal plane so the size of the image can be changed simply by moving the screen towards or away from the credential. Also, the image can be magnified in one axis only by tilting the screen away from the orientation normal to the reflected beam.

For the purposes of this disclosure, credentials are broadly defined and may include, for example, credit cards, bank cards, phone cards, passports, driver's licenses, network access cards, employee badges, debit cards, security cards, visas, immigration documentation, national ID cards, citizenship cards, social security cards, security badges, certificates, identification cards or documents, voter registration cards, police ID cards, border crossing cards, legal instruments or documentation, security clearance badges and cards, gun permits, gift certificates or cards, labels or product packaging, membership cards or badges, etc. Also, the terms “document,” “credential,” “card,” and “documentation” are used interchangeably throughout this document. Credentials are also sometimes interchangeably referred to as “security documents,” “ID documents,” “identification documents,” “security credentials,” “photo-IDs,” and “photo ID documents”.

It is also an aspect of the present disclosure to provide a system for verifying the authenticity of a credential as described herein. Specifically, an authentication system is disclosed which includes a light source configured to illuminate a credential with emitted light and a viewer configured to facilitate viewing of light reflected by the credential. In some embodiments, the viewer may include a viewing window and a viewing screen. If the illuminated credential is an authentic credential (e.g., a credential having a diffractive security feature), then an image may be displayed in the viewer. If the illuminated credential is not an authentic credential, then no image may be displayed in the viewer.

A method of verifying the authenticity of a credential is also provided. Specifically, the method includes illuminating a credential with light and analyzing the light that is reflected by the credential. Based on the analysis of the reflected light, the credential can be verified as authentic if an image is observed. Failure to observe an image in the reflected light may signify that the credential is not an authentic credential.

The present invention will be further understood from the drawings and the following detailed description. Although this description sets forth specific details, it is understood that certain embodiments of the invention may be practiced without these specific details. It is also understood that in some instances, well-known circuits, components and techniques have not been shown in detail in order to avoid obscuring the understanding of the invention.

### BRIEF DESCRIPTION OF THE DRAWINGS

The present disclosure is described in conjunction with the appended figures:

FIG. 1 is a perspective view of an authentication system in accordance with embodiments of the present disclosure;

FIG. 2 is a perspective view of an authenticator sub-assembly in accordance with embodiments of the present disclosure;

FIG. 3 is a perspective view of a simplified authentication system in accordance with embodiments of the present disclosure;

FIG. 4 is a plan view of a credential in accordance with embodiments of the present disclosure;

FIG. 5 is a schematic view of a series of images in motion in accordance with embodiments of the present disclosure; and

FIG. 6 is a flow diagram depicting an authentication method in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

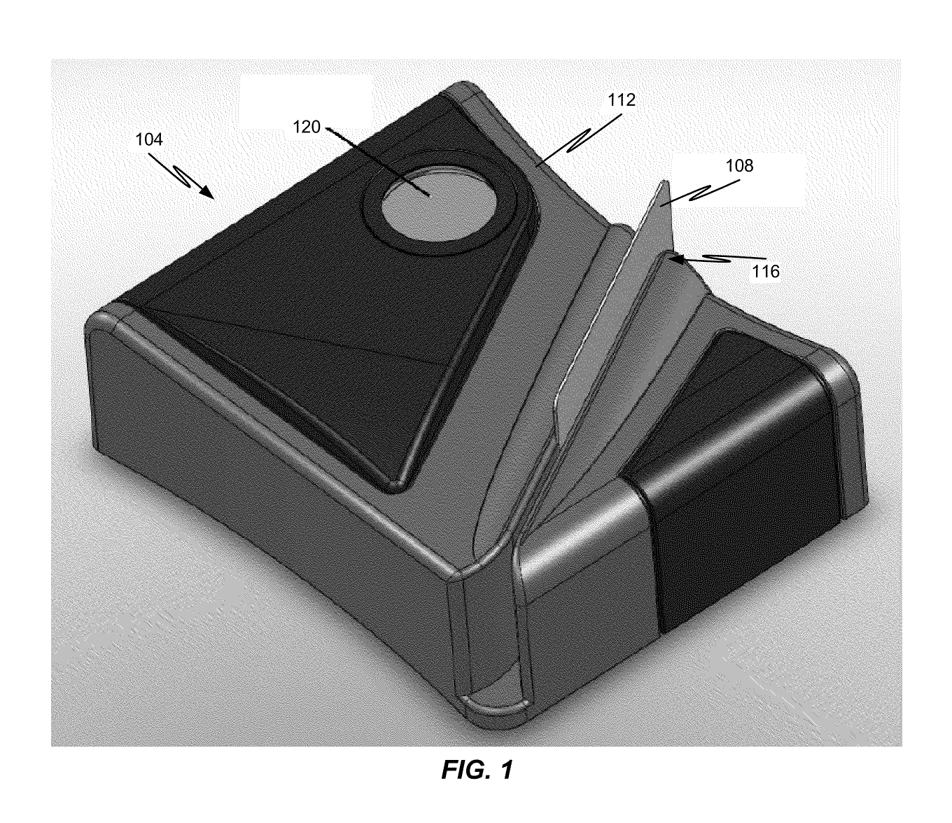

Referring initially to FIG. 1, an authentication system 104 will be described in accordance with embodiments of the present disclosure. Specifically, an authentication system 104 is depicted as comprising an authenticator housing 112 having a slot 116 configured to receive a credential 108 therein. The authenticator housing 112 may further include a viewer 120, which corresponds to a feature on the authenticator housing 112 that facilitates the viewing of light that is reflected off the credential 108 as it is slid through the slot 116.

In some embodiments, the authenticator housing 112 may be made of a light-weight but sturdy material. Examples of suitable materials for the authenticator housing 112 include, without limitation, plastic, ceramic, glass, metal, alloys, and combinations thereof. The authenticator housing 112 may be designed for simple hand-held use or it may be configured to be secured to an object such as a table, wall, or the like.

The viewer 120 may include one or more optical features that enhance viewing of images on a surface. For example, the viewer 120 may comprise one or more of a prism, lens, mirror, diffraction grating, or the like to enhance the viewing of light that is reflected off the credential 108. Alternatively, the viewer 120 may be a simple piece of plastic or glass that fills a hole in the authenticator housing 112. In such an embodiment, the viewer 120 is simply a viewing window to a viewing surface or screen contained within the authenticator housing 112.

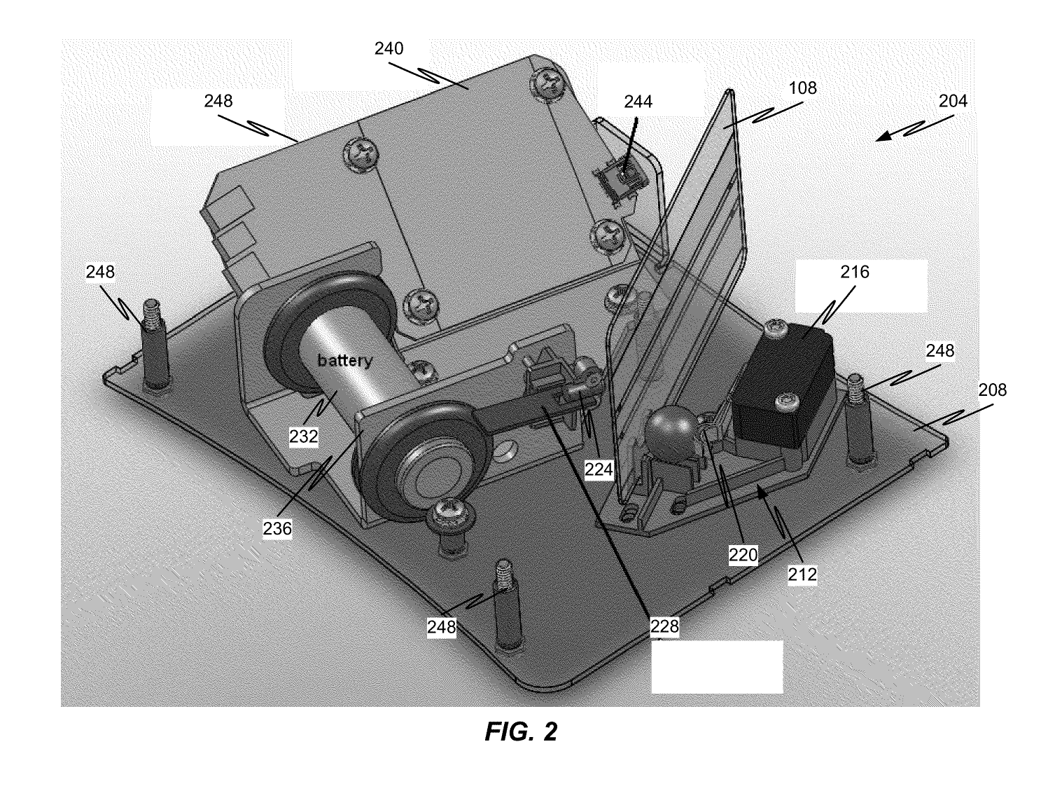

With reference now to FIG. 2, additional details of components contained within the authenticator housing 112 will be described in accordance with embodiments of the present disclosure. Specifically, an authenticator sub-assembly 204 is depicted that includes a support 208, a switch assembly 212, a light source 224 incorporated into a light module 228, and a viewing screen 240 positioned on a circuit board 248. The authenticator housing 112 may be secured to the support 208 with one or more connectors 248. The connectors, while depicted as comprising a nut-and-bolt system may be achieved with any known type of fastening or securing mechanism.

In some embodiments, the switch assembly 212 comprises various components to detect that a credential 108 has been inserted in the slot 116 and in response thereto, to activate other components of the authenticator sub-assembly 204. In particular, the switch assembly 212 may comprise a credential guide that is co-located in the slot 116. The credential guide may receive and hold the credential 108 is a particular position as it is slid through the slot 116.

The switch assembly 212 may also comprise a switch 216 and a switch actuator 220. The switch 216 and/or switch actuator 220 may include any collection of mechanical, electrical, or electromechanical devices that detect the presence of the credential 108 in the slot 116 and activate the light source 224 to illuminate the credential 108 while in the slot 116. In the depicted embodiment, the switch 216 comprises one or more electrical contacts that are connected when the actuator 220 is moved by the credential 108. The connection of the contacts at the switch 216 may cause one or more other circuits in the authenticator sub-assembly (e.g., an illumination circuit residing on the circuit board 248) to become closed and operational. This, in turn, causes the light source 224 to become activated and illuminate the credential 108. Although the actuator 220 is depicted as comprising a ball, spring, and lever arrangement, those of skill in the art will appreciate that any type of known switch-activation arrangement may be employed. As an example, the actuator 220 may be optically-based and may have an optical proximity sensor (e.g., photodiode, photosensor, etc.) that detects the presence of the credential 108 in the slot 116. Thereafter, the sensor may send an electrical signal to the switch 216, thereby causing the switch 216 to activate the light source 224.

As can be seen in FIG. 2, the switch assembly 212 may include various structures that fix or support the relative positions of the components of the switch assembly 212. In some embodiments, the structure may include scaffolding that is made of plastic that has been molded or otherwise manufactured. The scaffolding of the switch assembly 212 may be fastened, glued, or otherwise attached to the support 208, thereby fixing the position of the switch assembly 212 relative to other components of the authenticator sub-assembly 204.

The light module 228 may also be supported by a mounting bracket 236 that is fastened, glued, or otherwise attached to the support 208. In particular, the light module 228 may be connected to the mounting bracket 236 and the mounting bracket 236 may also provide a mounting location for a power source 232. In some embodiments, the light module 228 is directed toward the switch assembly 212 and particularly the slot 116. This enables the light source 224 to emit light toward the credential 108 when the credential 108 is located in the slot 116.

In some embodiments, when the switch 216 is activated by movement of the actuator 220, power is provided from the power source 232 to the light source 224. The power may be provided directly from the power source 232 to the light source 224, or it may be passed through one or more circuits and/or circuit elements residing on the circuit board 248.

The circuit board 248, in some embodiments, comprises one or more potentiometers that enable either the automated or manual adjustment of power provided to from the power source 232 to the light source 224. In embodiments where the power source 232 corresponds to a self-contained power source such as a battery, collection of batteries, or the like having a finite voltage supply, circuitry on the circuit board 248 may comprise a voltage or current regulator. The voltage or current regulator on the circuit board 248 may maintain constant optical power at the light source 224, even as voltage of the power source 232 decreases with loss of charge.

In embodiments where the power source 232 corresponds to a power converter (e.g., A/C to D/C power converter), the circuit board 248 may comprise one or more circuit elements that condition the power either before or after it has been converted to DC power before the power is provided to the light source 224. Alternatively, the need for additional power regulation circuitry on the circuit board 248 may become obsolete.

Although not depicted, it has been described that components of the switch assembly 212, the circuit board 248, the power source 232, and the light source 224 may operate in cooperation with one another. This means that the above-noted parts of the sub-assembly 204 may be electrically connected to one another via one or more of wires, conductive traces, and the like. Where conductive traces are used, the conductive traces may be established on the upper surface of the support 208.

The light source 224 may correspond to any type of known light source or collection of light sources. In particular, the light source 224 may correspond to any type of light source that is capable of producing collimated light as an output. Non-limiting examples of suitable light sources 224 include a laser and collimating lens, a laser diode, or any other device capable of producing coherent light. The light source 224 may be fastened or otherwise secured to a mounting portion of the light module 228, which accurately positions the light source 224 relative to the credential 108.

The mounting portion is attached to the mounting bracket 236 at any number of locations. In some embodiments, the mount location determines the viewer version and which types of credentials 108 are capable of being authenticated by the authenticator sub-assembly 204. More specifically, the light source 224 may be mounted at any number of different vertical positions, where each different vertical position results in a different portion of the credential 108 being illuminated. As one non-limiting example, the light source 224 may be mounted at about 26.8 mm from the bottom of the slot 116. As another non-limiting example, the light source 224 may be mounted at about 18.5 mm from the bottom of the slot 116. Thus, the authenticator housing 112 can be configured to authenticate credentials of different types having security features at different locations.

Similar to the mounting bracket 236 and switch assembly 212, the circuit board 248 may also be secured or otherwise fastened to the support 208. In addition to providing a mounting surface and traces between circuitry components for operating the light source 224, the circuit board 248 may also provide a flat surface for a screen 240 or the like. In particular, the screen 240 may correspond to either a reflective surface or a single-colored surface 240 that facilitates easy viewing of reflected light through the viewer 120. The screen 240, in some embodiments, may be constructed from a plastic material or high-quality photo paper and may have either a white or black color. If the screen 240 is reflective, the screen 240 may be either (1) a plastic material coated in a reflective material or (2) entirely manufactured from a reflective material. The screen 240 can be mounted to the circuit board 248 or it may be integrated therein.

In addition to supporting the screen 240, the circuit board 248 may also comprise a port 244 that enables the authentication system 104 to communicate with external devices. In some embodiments, the port 244 may correspond to a Universal Serial Bus (USB) port. Alternatively, or in addition, the port 244 may provide a mechanism for feeding or charging the power source 232. Even more specifically, the circuit board 248 may provide a battery charger which draws power from the port 244 whenever it is connected to a host device such as a computer. Where the port 244 corresponds to a USB port, the USB signal lines may not be connected so the host device does not ‘see’ the components of the authenticator sub-assembly 204 but does provide 5 volt power.

The circuit board 248 may also comprise a micro-controller which monitors the power source 232 voltage when the switch 216 is activated. If the voltage falls below a predetermined level, the processor flashes an LED on the circuit board 248 to warn the user that the power source 232 (e.g., battery) needs to be discharged. In some embodiments, the screen 240 may comprise a small hole located above or below the image area (e.g., an area where reflected light will be viewable through the viewer 120) that allows light from the low-voltage LED to pass through the screen 240 and be viewed through the viewer 120.

The power source 232 itself may also be provided with an internal circuit which disconnects the power source 232 from the circuit board 248 and light source 224 when its output voltage drops below a safe operating level. This prevents a deep discharge from damaging the power source 232.

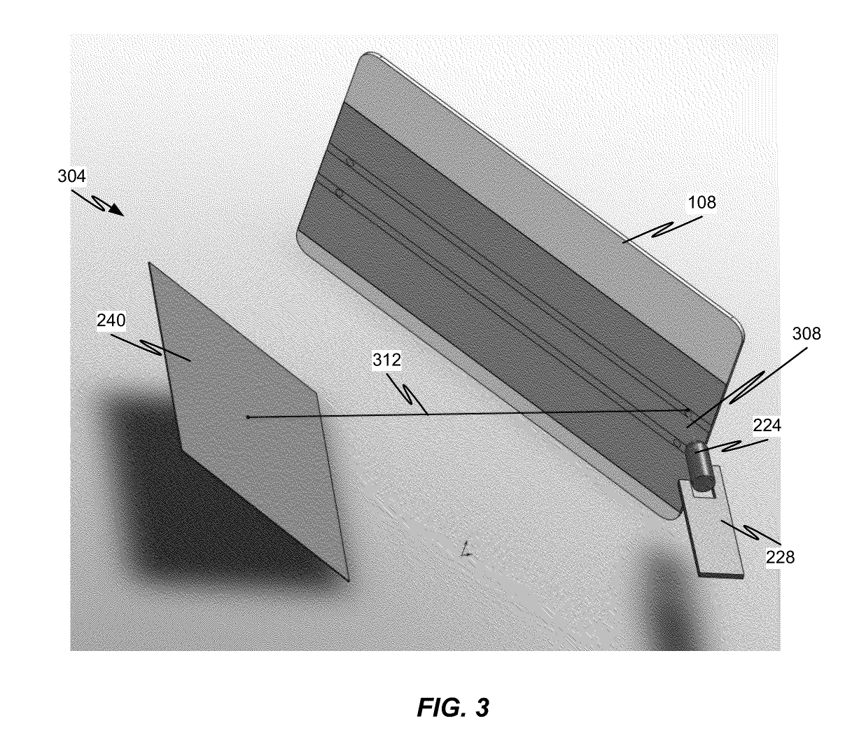

With reference now to FIG. 3, optical properties of the authenticator sub-assembly 204 will be described in connection with a simplified authentication system 304. Specifically, the simplified authentication system 304 is incorporated in or part of the authenticator sub-assembly 204. The simplified authentication system 304 shows the minimal components that enable an optical-based authentication of credentials 108. Specifically, the light module 228 comprises the light source 224 that emits a first beam of light, which may be referred to as emitted light 308. The emitted light 308 travels toward the credential 108 while the credential 108 is in the slot 116 and hits the credential 108.

The emitted light 308 then reflects off the credential and the reflected light 312 travels toward the screen 240. If the credential 108 is authentic and comprises one or more security features as described herein, then the reflected light 312 will display one or more predetermined images on the screen 240. The images displayed on the on the screen 240 are then viewable by a user through the viewer 120. If the credential 108 is not authentic, then no image will be created by the reflected light 312 and displayed on the screen 240.

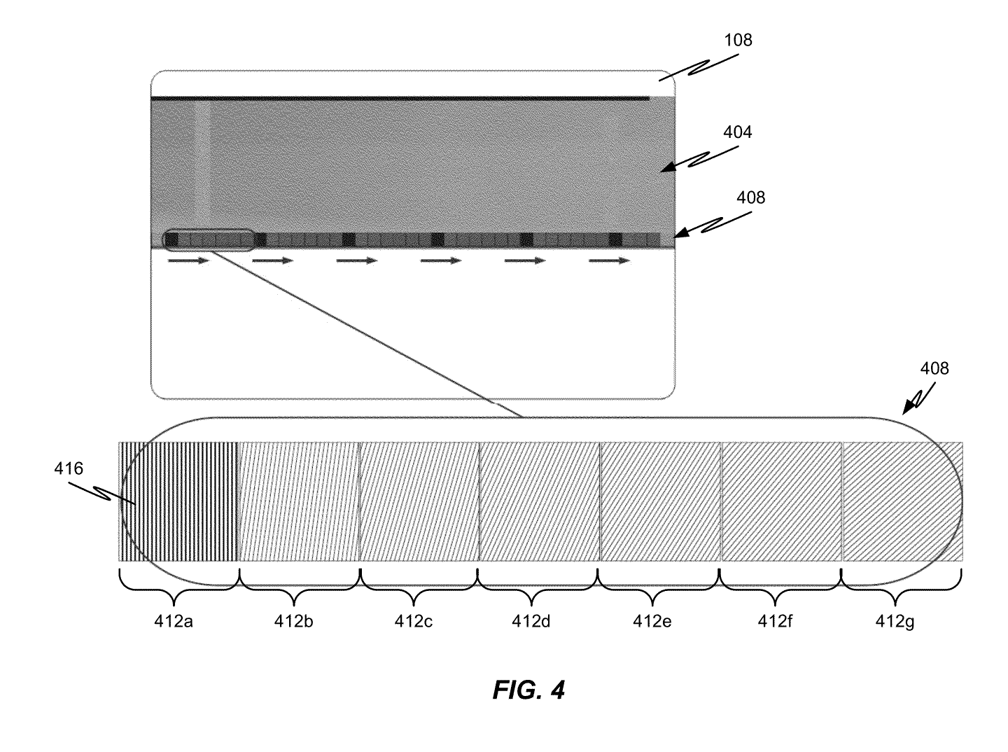

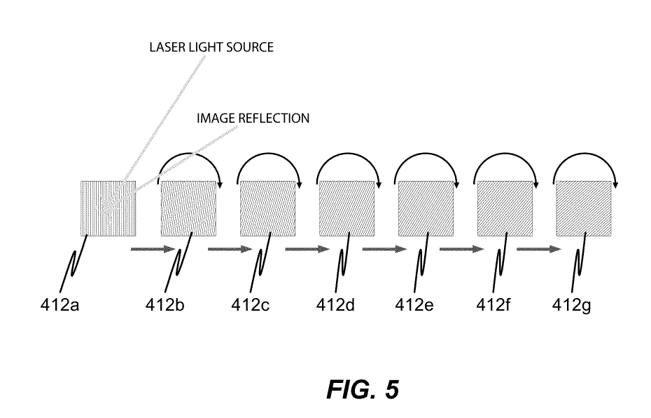

With reference now to FIGS. 4 and 5, additional details of an authentic credential 108 will be described in accordance with at least some embodiments of the present disclosure. More specifically, the credential 108 may be provided with a data region 404 and one or more security features 408. While the security feature 408 is depicted as being separate from the data region 404, it may be possible to combine the data region 404 and security feature 408 into a single region on the credential 108. In particular, the security feature 408 may be incorporated into the data region 404 and vice versa.

The security feature 408, in some embodiments, may comprise a plurality of diffractive elements 412a-g, where each diffractive element is separate and distinct from the other diffractive elements. Each diffractive element may also be referred to as an image. The difference from one diffractive element 412 to the next is that lines 416 in successive diffractive elements are rotated by a predetermined amount. The rotation of the lines 416 from one diffractive element (e.g., the first diffractive element 412a) to the next diffractive element (e.g., the second diffractive element 412b) creates a subtle difference from image to image, which allows the eye to see movement in the image displayed on the screen 240 by the reflected light 312. In some embodiments, as the credential 108 is moved through the slot 116 (e.g., in the direction of arrows depicted in FIG. 5), the emitted light 308 incrementally reflects off a different image (series of lines 116) and the user is able to view a moving image in the viewer 120. If the credential 108 is not authentic and does not comprise the security feature 408 as-disclosed, then images and specifically moving images will not be viewable through the viewer 120. The diffractive images (only lines) that go across the width of the card are only part of a primary image that is viewable with the eyes, making it discrete due to the subtle differences (line rotation) from image to image. Each set of line alignment will reflect back a shade to the eye and noise to the reader which is viewed as a line. Since the lines rotate about 10 degrees from one image to the next image, when you slide the card from one edge to the other, the viewer will display a single line that spins like a wheel.

Although the security feature 408 is depicted as having a repeating series of seven diffractive elements 412a-g, those of ordinary skill in the art will appreciate that the security feature 408 may comprise a greater or lesser number of diffractive elements without departing from the scope of the present disclosure. Furthermore, the security feature 408 may comprise only a single set of diffractive elements 412. Further still, the credential 108 may comprise more than one security feature 408.

The security feature 408 and specifically the independent diffractive elements 412a-g of the security feature 408 may be created by any number of processes. As one non-limiting example, the security feature 408 is produced with the application of a high resolution black and white silver halide photographic film. The film is imaged using high resolution contact masks with spot sizes down to about 2.5 microns. The film is imaged with visible light but the film is sensitized in the near UV. The film silver halide grain size is submicron and the film is capable of resolving images close to 1 micron. The film has high contrast so that exposed and processed areas of the film have maximum optical diffraction and the unexposed areas have high transparency.

The film is then contact printed using masks created from photomask masters. A chrome on quartz glass master plate is written with electron beams, sputtering or evaporating away the chrome where the beam contacts the plate. The process is similar to that used to create the masters for chip manufacturing. The areas sputtered away transmit light and the areas with chrome block the light completely.

Master film is created by replicating the plate with high resolution high contrast photographic film. The film process is reversed so that the film is representative of the initial master. The chromed areas of the photomask master have high optical density on the master film and look black. The quartz glass areas where the chrome has been removed being low optical density on the film replica and are transparent.

From this master film the media film is imaged using contact printing. The areas exposed are not reversed in this case but are developed normally to create dark images where the light contacts the film. After the initial development of the dark images the remaining silver is not washed out as it would in normal black and white photographic film processing, but migrated to the surface of the film using a special process. Once the silver halide is at the surface of the film, the halides are converted to silver to form a reflective silver surface. The remaining halides in the film are then developed and fixed in the film. The final media film looks like a reflective silver with dark near black printing on it.

For this media to function for the life of the credential the silver surface should be protected. The silver at the surface of the film will oxidize within hours of being exposed in the air. The media is therefore handled without air contact and then encapsulated in polymer resin to protect the media from air and water.

Although embodiments of the present disclosure discussed the use of linear lines 416 to be printed in each diffractive element 412 and the lines 416 in successive diffractive elements are to be rotated by a predetermined amount, it should be appreciated that features other than lines may be used. Specifically, the series of images may have non-linear lines, shapes, curves, etc. that result in any type of animation or depiction of multiple images as the credential 108 is moved though the slot 116 and different diffractive elements 412 are illuminated.

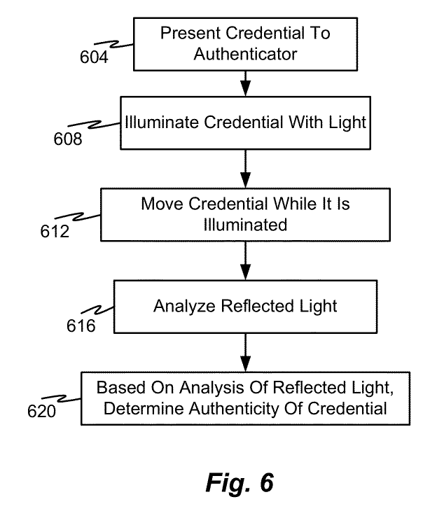

With reference now to FIG. 6, an authentication method will be described in accordance with at least some embodiments of the present disclosure. The method begins when a credential is presented to the authentication system 104 (step 604). This step may involve placing the credential 108 into the slot 116 of the authentication system 104 such that the actuator 220 is moved, thereby activating the switch 216.

When the credential 108 is presented to the authentication system 104, the method continues by illuminating the credential 108 with emitted light 308 (step 608) and moving the credential 108 within the slot 116 such that different parts of the security feature 408, if present, are illuminated (step 612).

The light which reflects off the credential 108 as the credential 108 moves is then analyzed (step 616). Analysis of the reflected light 312 may involve observing the reflected light 312 through the viewer 120 to determine whether the reflected light 312 displays one or more images. Alternatively, or in addition, analysis of the reflected light 312 may involve determining whether the reflected light 312 or an image produced thereby is moving on the screen 240.

Based on an analysis of the reflected light 312, the authenticity (or lack thereof) is determined (step 620). In particular, if the reflected light 312 produced one or more images or created some other indication that the emitted light 308 was reflected by a security feature 408, then the credential 108 can be confirmed as authentic. If, however, the reflected light 312 fails to produce any indication that it was reflected by a security feature 408 or a similar component, then the credential may be considered not authentic or may require further authenticity testing.

In the foregoing description, for the purposes of illustration, methods were described in a particular order. It should be appreciated that in alternate embodiments, the methods and steps thereof may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. In other words, the methods described herein can be performed by a human (manually) or a machine (automatically). In an automated implementation, the machine-executable instructions may be stored on one or more machine readable mediums, such as CD-ROMs or other type of optical disks, floppy diskettes, ROMs, RAMs, EPROMs, EEPROMs, SIMs, SAMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method of authenticating a credential, comprising:
illuminating the credential with light from a light source;
moving the credential such that different portions of the credential are illuminated with the light from the light source;
analyzing light that reflects off the credential as the credential is moving; and
based on the analysis of the reflected light, making an authenticity determination for the credential.

2. The method of claim 1, further comprising:
observing the reflected light via a viewer for at least one of motion of the reflected light and the creation of an image with the reflected light.

3. The method of claim 2, further comprising:
determining that the credential is authentic in response to motion of the reflected light in the viewer.

4. The method of claim 2, further comprising:
determining that the credential is authentic in response to observing the creation of the image with the reflected light.

5. The method of claim 1, wherein the credential is determined to be authentic in response to determining that the reflected light produces an indication that the credential comprises one or more diffractive elements.

6. The method of claim 5, wherein the one or more diffractive elements comprise a series of diffractive elements, each having a plurality of lines that are rotated relative to an adjacent diffractive element by a predetermined amount.

7. A credential authentication system, comprising:
a light source configured to illuminate a credential with emitted light; and
a viewer configured to facilitate viewing of light reflected by the credential as the credential is moved and different portions of the credential are illuminated with the emitted light.

8. The system of claim 7, wherein the viewer comprises at least one of a viewing window and a viewing screen.

9. The system of claim 7, further comprising:
a guide configured to maintain a position of the credential in a first dimension relative to the light source but not in a second dimension relative to the light source so that the credential can be moved in the second dimension while being illuminated by the light source.

10. The system of claim 9, further comprising:
a switch assembly configured to detect a presence of the credential in the guide and, in response thereto, activate the light source.

11. The system of claim 7, wherein the emitted light comprises a collimated beam of light.

12. The system of claim 7, wherein the light source comprises a laser.

13. The system of claim 7, further comprising:
a power source configured to provide power to the light source thereby enabling the light source to generate the emitted light.

14. The system of claim 13, further comprising:
a voltage regulator that conditions the power source to maintain a substantially constant optical power at the light source, even as voltage of the power source decreases with loss of charge.

15. The system of claim 14, further comprising:
a circuit board that includes the voltage regulator and provides a surface for viewing the reflected light.
